(19) United States
(12) Patent Application Publication
(10) Pub. No.: US 2014/0017029 A1
(43) Pub. Date: Jan. 16, 2014

(54) LOCKING ASSEMBLY PROVIDING ATTACHMENT BETWEEN CANTED WORKPIECES

(71) Applicants: HON HAI PRECISION INDUSTRY CO., LTD., New Taipei (TW); FU TAI HUA INDUSTRY (SHENZHEN) CO., LTD., Shenzhen (CN)

(72) Inventor: ZHI-HUA LIU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/904,259

(22) Filed: May 29, 2013

(30) Foreign Application Priority Data
Jul. 16, 2012 (CN) 2012102449586

(51) Int. Cl. F16B 39/28

(52) U.S. Cl. CPC F16B 39/28
USPC 411/166

(57) ABSTRACT

A locking assembly includes a locking member and an engaging member. The locking member includes a blocking portion and a locking portion. The blocking portion comprises an end surface and a resisting surface opposite to the end surface. The locking portion extends from the resisting surface. The resisting surface is a rounded surface. The engaging member engages with the locking member. The engaging member comprises an engaging surface adjacent to the blocking portion of the locking member. The engaging surface is a rounded surface.

### BACKGROUND

1. Technical Field

The present disclosure relates to locking assemblies, particularly to a locking assembly for locking two or more than two workpieces together.

2. Description of Related Art

Workpieces are usually locked together via screws after many processes. For example, a housing of an electronic device may be punched, annealed, cleaned, anodized, and then may be locked with a circuit board after such processes. However, each process for the housing may affect a profile of the housing, which results in non-perpendicularity when the screws are tightened with the workpieces. In addition, during the locking of the workpieces, an operation error may be happened, and a deviation or canting of the circuit board or the housing may occur. Thus, when the screws are tightened into the workpieces, the workpieces may be deformed and the circuit board may be strained or even damaged by the screws due to the deviations or canting.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an embodiment of a locking assembly in a first state of use.

FIG. 2 is an exploded view of the locking assembly in FIG. 1.

FIG. 3 is a sectional view along line III-III of the locking assembly in FIG. 1 in the first state of use.

FIG. 4 is a sectional view along line III-III of the locking assembly in FIG. 1 in a second state of use.

### DETAILED DESCRIPTION

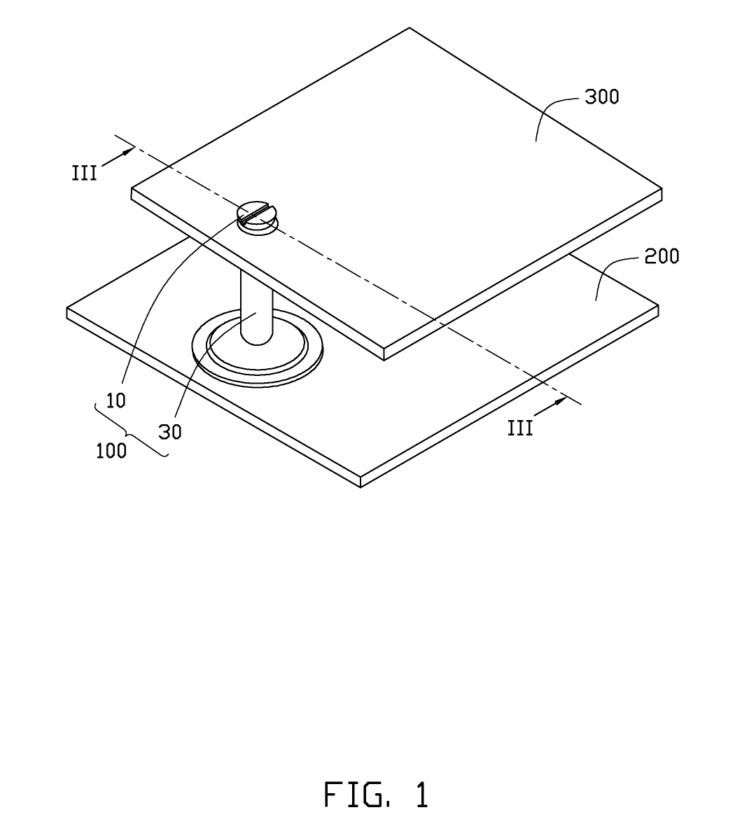

FIG. 1 shows a locking assembly 100 of one embodiment. The locking assembly 100 locks a first workpiece 200 and a second workpiece 300 together. The locking assembly 100 includes a locking member 10 and an engaging member 30. The locking member 10 couples with the engaging member 30 to lock the first workpiece 200 and the second workpiece 300 together. In the illustrated embodiment, the first workpiece 200 is a housing. The second workpiece 300 is a circuit board.

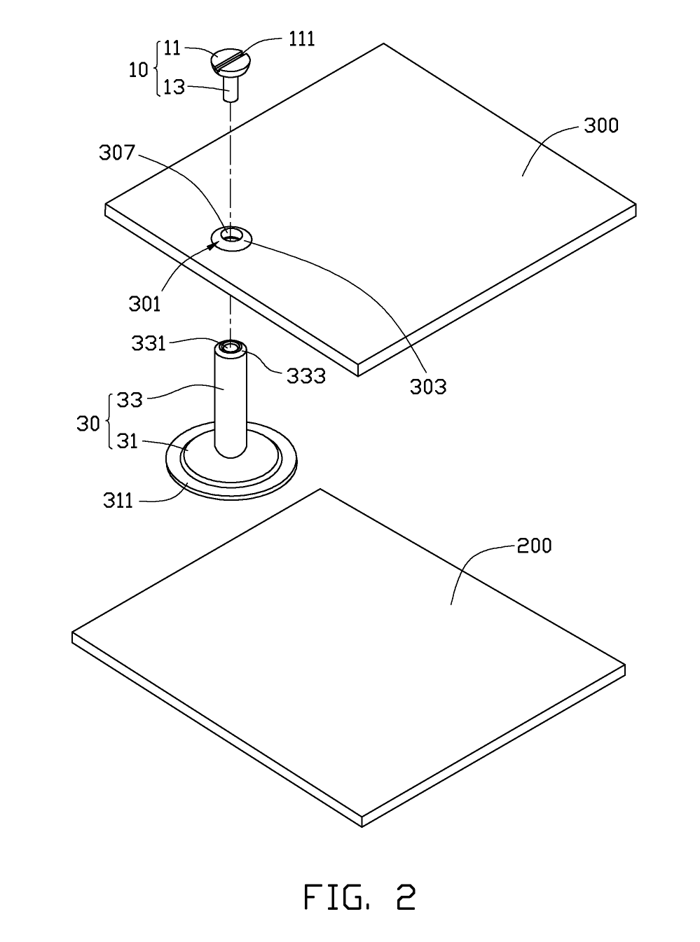

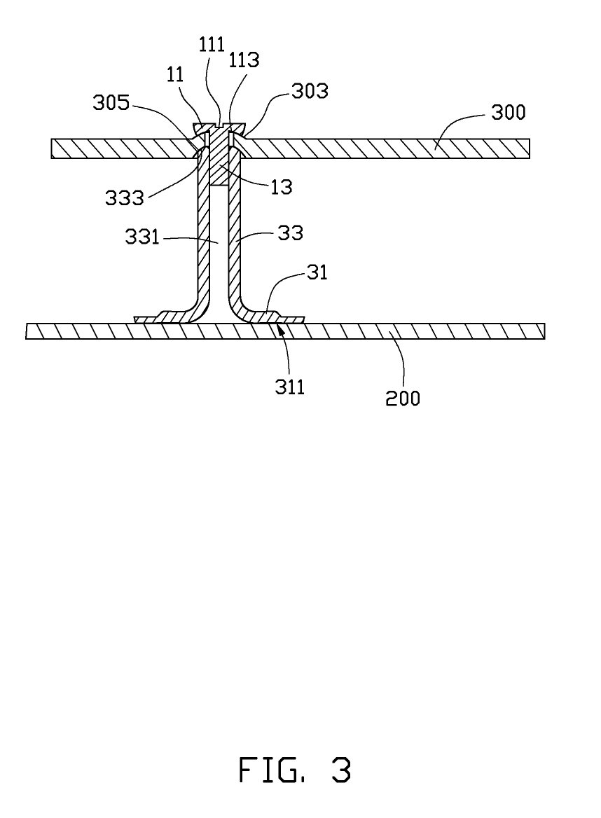

FIGS. 2 and 3 show the locking member 10 including a blocking portion 11 and a locking portion 13. The blocking portion 11 is substantially circular, and includes an end surface 112 and a resisting surface 113 (shown in FIG. 3) opposite to the end surface 112. The end surface 112 defines a crosscut 111 therein. The crosscut 111 allows a tool (not shown) to rotate and screw the locking member 10 home. The resisting surface 113 is an rounded and curved surface. When the locking assembly 100 locks the first workpiece 200 with the third workpiece 300, the resisting surface 113 resists the second workpiece 300. The locking portion 13 is substantially columnar, and substantially perpendicularly extends from the resisting surface 113. The locking portion 13 has threads at an outer side surface thereof. In the illustrated embodiment, the resisting surface 113 is substantially a rounded concave depression. In an alternative embodiment, the blocking portion 11 may be other shapes, such as polygonal.

The engaging member 30 includes a fixing portion 31 and a fastening portion 33 formed on an end of the fixing portion 31. The fixing portion 31 is configured to be fixed to the first workpiece 200. The fixing portion 31 is substantially a disc, and includes a positioning surface 311 at an end away from the fastening portion 33. The positioning surface 311 is fixed to the first workpiece 200 in a substantially perpendicular manner. The fastening portion 33 is substantially columnar, and includes an engaging surface 333 at an end away from the fixing portion 31. The engaging surface 333 of the fastening portion 33 defines a central engaging hole 331. The engaging hole 331 is threaded for engaging with the locking portion 13. The engaging surface 333 is substantially a rounded and raised surface. In the illustrated embodiment, the engaging surface 333 is substantially a convex surface matching the shape of the resisting surface 113. A diameter of the engaging surface 333 is substantially equal to that of the resisting surface 113.

The second workpiece 300 includes a mounting portion 301. The mounting portion 301 includes a first securing surface 303 and a second securing surface 305. The first securing surface 303 and the second securing surface 305 are located at opposite sides of the second workpiece 300. The first securing surface 303 is rounded and curved, and a shape of the first securing surface 303 matches with a shape of the resisting surface 113. The second securing surface 305 is also rounded and curved, and a shape of the second securing surface 305 matches with a shape of the engaging surface 333. The mounting portion 301 defines a through hole 307 in the first securing surface 303 toward the second securing surface 305, for allowing generous clearance for the locking portion 13 to pass through. A diameter of the through hole 307 is larger than a diameter of the engaging hole 331. In the illustrated embodiment, the first securing surface 303 is convex and substantially rounded and curved, to match with the resisting surface 113. The second securing surface 305 has a concave shape suitable for receiving and locating the engaging surface 333. A diameter of the first securing surface 303 is equal to a diameter of the second securing surface 305, and the diameter is equal to the diameter of the resisting surface 113.

In use, the fixing portion 31 of the engaging member 30 is fixed to the first workpiece 200. In the illustrated embodiment, the positioning surface 311 of the engaging member 30 is positioned on the first workpiece 200 via a double sided adhesive tape for example. The second workpiece 300 is put on the fastening portion 33 of the engaging member 30, and the second securing surface 305 resists on the engaging surface 333. The through hole 307 is aligned with the engaging hole 331. Then, the locking portion 13 of the locking member 10 is inserted into the through hole 307 and the engaging hole 331, and the locking portion 13 is locked with the fastening portion 33. The first securing surface 303 resists the resisting surface 113. Therefore, the first workpiece 200 and the second workpiece 300 are locked together via the locking assembly 100. A first locking state is shown in FIG. 3, and an axis of the through hole 307 is coaxial and concentric with an axis of the engaging hole 331 in this state.

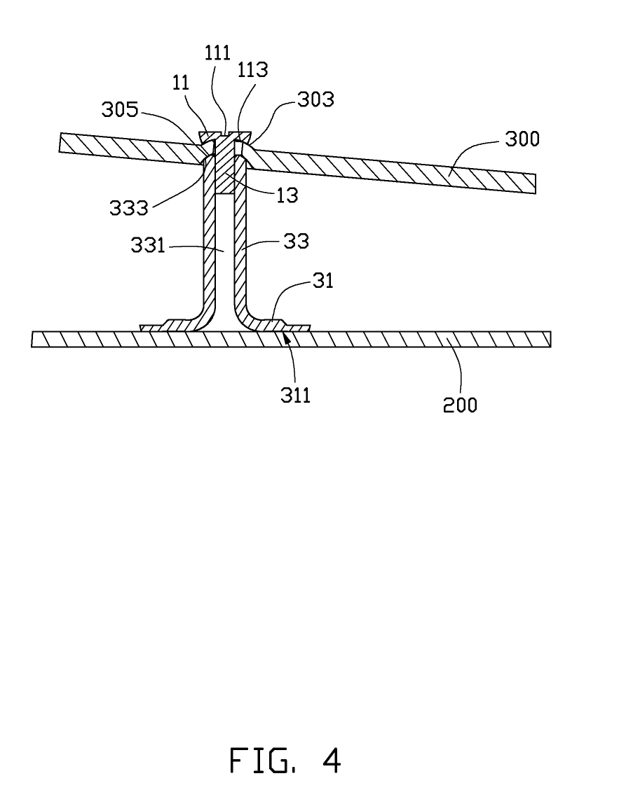

When a deviation or canting of the second workpiece 300 and the fastening portion 33 exists, and the axis of the through hole 307 is not coaxial with the axis of the engaging hole 331, because the second securing surface 305 is an rounded surface matching with the engaging surface 333, the second securing surface 305 can still make solid and supported contact with the engaging surface 333 without any gaps, and because the first securing surface 303 is an rounded surface matching with the resisting surface 113, the first securing surface 303 can still provide a firm base for the resisting surface 113 without any gaps. A second state is shown in FIG. 4, and the second workpiece 300 is canted in this state, the through hole 307 being not coaxial with the axis of the engaging hole 331 in this state.

In an alternative embodiment, the engaging member 30 may be fixed to the first workpiece 200 in other ways, such as the engaging member 30 being fixed to the first workpiece 200 via screws (not shown) for example. The resisting surface 113 may be a convex surface, and the first securing surface 303 may be correspondingly concave. The engaging surface 333 may be curved and concave, and the second securing surface 305 may be a curved and convex surface correspondingly.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A locking assembly comprising:
a locking member comprising a blocking portion and a locking portion, the blocking portion comprising an end surface and a resisting surface opposite to the end surface, the locking portion extending outward from the resisting surface, wherein the resisting surface is a rounded surface; and
an engaging member engaging with the locking portion of the locking member, the engaging member comprising an engaging surface adjacent to the blocking portion of the locking member, wherein the engaging surface is a rounded surface.

2. The locking assembly of claim 1, wherein the resisting surface is a rounded and concave surface, the engaging surface is a rounded and convex surface.

3. The locking assembly of claim 1, wherein the resisting surface is a rounded and convex surface, the engaging surface is a rounded and concave surface.

4. The locking assembly of claim 1, wherein the engaging member comprises a fixing portion and a fastening portion connected to the fixing portion, the engaging surface is an end surface of the fastening portion away from the fixing portion, the engaging surface defines an engaging hole, the locking portion is inserted into the engaging hole, and is engaged with the engaging portion.

5. A locking assembly comprising:
a locking member comprising a blocking portion and a locking portion, the blocking portion comprising an end surface and a resisting surface opposite to the end surface, the locking portion extending outward from the resisting surface, wherein the resisting surface is a rounded surface; and
an engaging member engaging with the locking portion of the locking member, the engaging member comprising an engaging surface adjacent to the blocking portion of the locking member, wherein the engaging surface is a rounded surface;
a first workpiece; and
a second workpiece comprising a mounting portion,
wherein the mounting portion comprises a first securing surface and a second securing surface at two opposite sides of the second workpiece, the first securing surface defines a through hole towards the second securing surface, the first securing surface is a rounded surface matching with the resisting surface, the second securing surface is a rounded surface matching with the engaging surface, when the locking assembly locking the first workpiece and the second workpiece, the engaging member is fixed to the first workpiece, the first securing surface resists the resisting surface, the second securing surface resists the engaging surface.

6. The locking assembly of claim 5, wherein the engaging member comprises a fixing portion and a fastening portion connected to the fixing portion, the engaging surface is an end surface of the fastening portion away from the fixing portion, the engaging surface defines an engaging hole, when the locking assembly locking with the first workpiece and the second workpiece, the locking portion is inserted into the through hole and the engaging hole, and is engaged with the engaging portion, the fixing portion is fixed to the first workpiece.

7. The locking assembly of claim 5, wherein a diameter of the through hole is larger than a diameter of the engaging hole.

8. The locking assembly of claim 5, wherein a diameter of the first securing surface is equal to a diameter of the resisting surface, a diameter of the second securing surface is equal to a diameter of the engaging surface.

9. The locking assembly of claim 5, wherein a diameter of the resisting surface is equal to a diameter of the engaging surface.

10. The locking assembly of claim 5, wherein the resisting surface is a rounded and concave surface, and the first securing surface is a rounded and convex surface matching with the resisting surface.

11. The locking assembly of claim 5, wherein the engaging surface is a rounded and convex surface, and the second securing surface is a rounded and concave surface matching with the engaging surface.

12. The locking assembly of claim 5, wherein the resisting surface is a rounded and convex surface, and the first securing surface is a rounded and concave surface matching with the resisting surface.

13. The locking assembly of claim 5, wherein the engaging surface is a rounded and concave surface, and the second securing surface is a rounded and convex surface matching with the engaging surface.
